(19) United States
(12) Patent Application Publication
(10) Pub. No.: US 2015/0169515 A1
(43) Pub. Date: Jun. 18, 2015

(54) DATA DRIVEN SYNTHESIZER

(71) Applicant: Target Brands, Inc., Minneapolis, MN (US)

(72) Inventors: Scott C. Hagen, Osceola, WI (US); Darryl Wheaton, Lakeville, MN (US)

(73) Assignee: Target Brands, Inc., Minneapolis, MN (US)

(21) Appl. No.: 14/104,921

(22) Filed: Dec. 12, 2013

(51) Int. Cl. G06F 17/22; G06F 17/30

(52) U.S. Cl. CPC G06F 17/2264; G06F 17/30371; G06F 17/30011

(57) ABSTRACT

A data driven synthesizer (DDS) may receive one or more instructions included in a recipe, wherein the one or more instructions specify a template for retrieving data from one or more data sources. In response to receiving the one or more instructions, the DDS may retrieve the data from the one or more data sources using the template, including inserting one or more values specified by the one or more instructions in place of one or more parameters in the template. The DDS may enable one or more transformation to be performed on the data based on the one or more instructions. The DDS may insert the transformed data into one or more locations in a data store specified by the one or more instructions.

### TECHNICAL FIELD

The disclosure relates to a system for data analysis and data reporting.

### BACKGROUND

An analyst often analyzes data and presents the data in reports. The analyst may need to retrieve data from multiple data sources. To access the data sources, such as databases or application programs, the analyst may be required to write separate computer code to access each of these different data sources. After retrieving the necessary data, the analyst may use a statistical analysis application to analyze and transform the retrieved data before the data can be placed in the appropriate parts of a report.

### SUMMARY

In general, the disclosure is directed to techniques for automating report generation and for separating the tasks of an analyst from that of a database programmer, so that the analyst does not have to know how to program a database to retrieve data. A digital data synthesizer (DDS) may automate the process of data retrieval and report generation, and may remove the burden of data collection from the analyst. The DDS introduces two concepts: recipes and templates. The DDS may receive a recipe that includes a sequence of instructions that directs the DDS to perform a series of tasks to generate a desire report. An analyst may create a recipe that specifies the data to be collected, the data source from which the data is collected, transformations to be performed on the data, and where the data may be stored in a data store. A subject matter expert for a specific data source may create a template that includes code to retrieve data from the specific data source. An analyst can take advantage of a template by referencing the template in the recipe to retrieve data from the data source associated with the recipe. The DDS may receive the recipe and may execute the sequence of instructions included in the recipe. In this way, the process for report generation can be automated.

Furthermore, by separating recipes from templates, analysts do not need to become subject matter experts for the various data sources used by the DDS. Instead, analysts can create custom recipes for their own analytics purposes that references already created templates created by subject matter experts to easily be able to retrieve, manipulate, and present a variety of data from a variety of data sources in a flexible manner. In this way, an analyst may control the entire process of retrieving, transforming, and storing data by writing the appropriate instructions in a recipe.

Benefits of the techniques disclosed in the present disclosure may include workflow efficiencies and time savings compared to previous techniques. The techniques disclosed herein may reduce errors, and may produce reports in a standardized format and in a consistently timely manner. Analysts may no longer have the burden of data collection and may have more control in producing specific reports.

In one aspect, the disclosure is directed to a method. The method may include receiving, by a data driven synthesizer running on at least one processor, one or more instructions included in a recipe, wherein the one or more instructions specify a template for retrieving data from one or more data sources. The method may further include in response to receiving the one or more instructions, retrieving, by the data driven synthesizer, the data from the one or more data sources using the template, including inserting one or more values specified by the one or more instructions in place of one or more parameters in the template. The method may further include performing one or more transformations on the data based on the one or more instructions. The method may further include inserting the transformed data into one or more locations in a data store specified by the one or more instructions.

In another aspect, the disclosure is directed to a computer-readable medium. The computer-readable medium may include instructions that, when executed by at least one processor, cause the at least one processor to perform operations. The operations may include receiving, by a data driven synthesizer, one or more instructions included in a recipe, wherein the one or more instructions specify a template for retrieving data from one or more data sources. The operations may further include, in response to receiving the one or more instructions, retrieving, by the data driven synthesizer, the data from the one or more data sources using the template, including inserting one or more values specified by the one or more instructions in place of one or more parameters in the template. The operations may further include inserting the data into one or more locations in a data specified by the one or more instructions. The operations may further include triggering one or more macros that operate on the data stored in the data store based on the one or more instructions.

In another aspect, the disclosure is directed to a system. The system may include at least one processor. The system may further include at least one memory device. The system may further include at least one module stored by the at least one memory device and executable by the at least one processor, wherein the at least one module is configured to perform operations comprising: receiving, by a data driven synthesizer, one or more instructions included in a recipe, wherein the one or more instructions specify a template for retrieving data from one or more data sources; in response to receiving the one or more instructions, retrieving, by the data driven synthesizer, the data from the one or more data sources using the template, including inserting one or more values specified by the one or more instructions in place of one or more parameters in the template; performing one or more transformations on the data based on the one or more instructions; and inserting the transformed data in place of one or more paste tags in a document based on the one or more instructions.

The details of one or more aspects of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating a system for generating reports of data according to some aspects of the present disclosure.

FIG. 2 is a block diagram illustrating an example computing device according to some aspects of the present disclosure.

FIG. 3 is a block diagram illustrating an example system for generating reports of coupon usage according to some aspects of the present disclosure.

FIG. 4 is a block diagram illustrating an example system for generating reports of data using nested recipes according to some aspects of the present disclosure.

FIG. 5 is a conceptual diagram illustrating an example generated report according to some aspects of the present disclosure.

FIG. 6 is a conceptual diagram illustrating an example user interface for generating reports according to some aspects of the present disclosure.

FIG. 7 is a flowchart illustrating a method for generating reports of data according to some aspects of the present disclosure.

### DETAILED DESCRIPTION

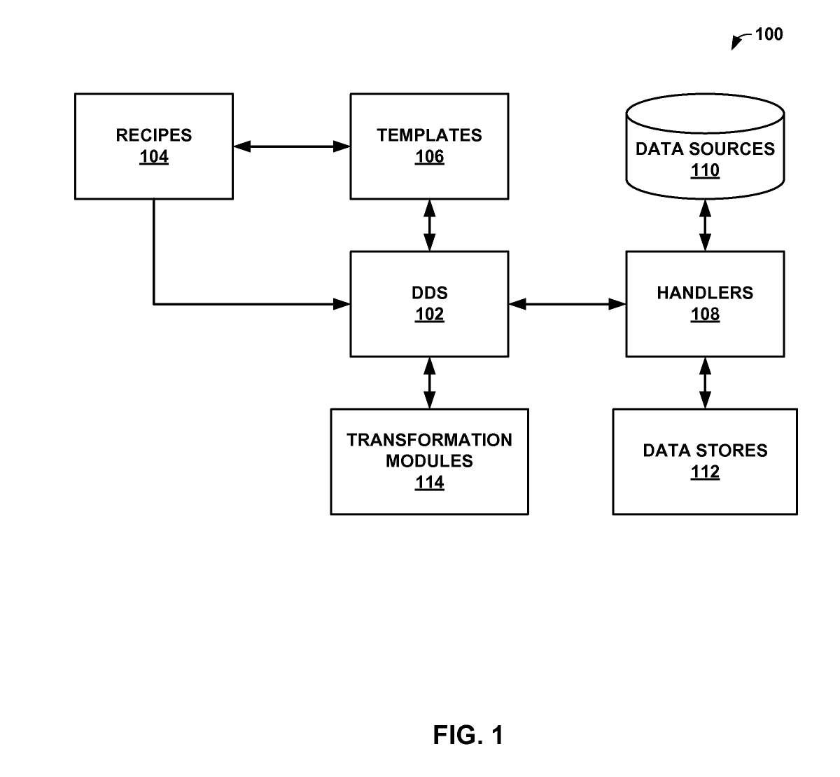

FIG. 1 is a block diagram illustrating a system 100 for generating reports of data according to some aspects of the present disclosure. As shown in FIG. 1, system 100 includes a data driven synthesizer (DDS) 102 and one or more recipes 104. Each recipe 104 includes a set of instructions for retrieving and/or transforming data from one or more of data sources 110. Each of recipes 104 may refer to one or more templates 106, each of which is associated with one or more of data sources 110. Each of recipes 104 may further refer to one or more transformation modules 114, which govern transformation of data retrieved from data sources 110 according to the instructions included in the recipe 104. The transformed data may be stored in one or more data stores 112 as specified in the recipe 104. One or more handlers 108, each associated with one of data sources 110 or one of data stores 112, permit DDS 102 to communicate with data sources 110 and/or data stores 112.

Recipes 104 may be processed by DDS 102 to retrieve data from one or more data sources 110. The retrieved data may be transformed by transformation modules 114, and the transformed data may be stored in data stores 112. Reports may be generated as specified by recipes 104 based on data received from data sources 110 and/or on transformed data stored in data stores 112. By creating or editing recipes 104, a user such as a business analyst may be able to produce reports based on data from multiple data sources 110. The reports may be generated on a scheduled or as needed basis.

Data driven synthesizer (DDS) 102 may act as an interchange from the recipes 104 to retrieve data from data sources requested by recipes 104, to enable the retrieved data to be transformed or otherwise processed as specified by recipes 104, and to place that retrieved and transformed data into specified locations within data stores and/or other documents as specified by recipes 104.

Recipes 104 may include domain-specific language that may be used to create instructions to control DDS 102. For example, recipes 104 may include documents such as text files that include a set of instructions written in a domain-specific language for processing by DDS 102. The set of instructions included in recipes 104 may include one or more of requests for data from data sources, file system commands, data transformation and processing, database persistence, copying of data to data stores, execution of macros or other instructions to operate on the stored data, and the like.

The instructions in recipes 104 may include a reference to templates 106. Each of templates 106 may be uniquely associated with one of data sources 110 and may include code specific to the data source. For example, if one of data sources 110 is based on a relational database model (RDBMS), then the associated template may include instructions written in structured query language (SQL) designed to manage data held in such a relational database. In other examples, templates 106 may include code written in shell scripting language, Perl, a data source specific application programming interface, and the like. Because in this example, each of templates 106 are unique to one of data sources 110, each of recipes 104 may, by specifying a particular template, also specify a data source associated with the template from which to retrieve data. Templates 106 may be parameterized so that they may include one or more parameters, such as [PageURL]. Recipes 104 may provide the values of the parameters in the referenced template, such as by including an instruction [PageURL]=www.target.com. DDS 102 may insert values for the parameters into the referenced template based on the values specified for those parameters in the recipe, and DDS 102 and may pass the template to a handler of handlers 108. The handler may execute the template passed by DDS 102 to retrieve data from the associated one of data sources 110.

Data sources 106 may include databases, applications, file systems, calendars, text files, application programming interfaces, and any other suitable source of data from which data may be retrieved. DDS 102 may communicate with a data source data sources 110 through a handler of handler 108 associated with the data source to request and receive data from the data source. DDS 102 is extendable to communicate with and retrieve data from any data source by using an appropriate handler for the data source.

Handlers 108 may include software that allows DDS 102 to communicate with data sources 108. Each of handlers 108 is uniquely associated with one of data sources 110 or one of data stores 112. Handlers 108 may provide a common set of commands that DDS 102 may use to communicate with data sources 110 and/or data stores 112. Example handlers may include Open Database Connectivity (ODBC) handlers, SiteCatalyst API handlers, file system handers, file transfer protocol (FTP) handlers, Microsoft Excel macro handlers, data warehouse API handlers, ad server handlers, and the like. Handlers 108 may be attachable, so that a specific handler for a data source may be attached to DDS 102 in response to DDS 102 requesting data from the data source associated with the specific handler. Similarly, DDS 102 may also use handlers 108 to communicate with data stores 112, so that DDS 102 may utilize a specific hander of handlers 108 associated with a specific data store of data stores 112 to communicate with data stores 112. In some examples, DDS 102 may not use a handler of handlers 108 to communicate with a specific data store. For example, if a data store is a Microsoft Office document, DDS 102 may use Apache POI to directly manipulate the data model of the document.

Transformation modules 114 may transform the data retrieved from data sources 110 according to the instructions included in recipes 104. Recipes 104 may specify one or more transformation modules 114 to transform the retrieved data. Recipes 104 may further specify the functionality of the specified transformation module 114 to be performed on the retrieved data. Transformation modules 114 may include, for example, statistical analysis applications, data analysis software, and the like. Transformation modules 114 may also include, for example, functionality such as arithmetic functions, financial functions, statistical functions, probability functions, and the like.

Recipes 104 may specify that the data retrieved from data sources 110 and transformed by transformation modules 114 be stored in one or more of data stores 112. Examples of data stores 112 may include databases, spreadsheets, slide show presentations, word processing documents, flat files, file systems, and the like. In one example, if one of data stores 112 includes one or more Microsoft Office documents, such as a Microsoft Excel spreadsheet, DDS 102 may utilize Apache POI to interface and directly manipulate the data model of the document.

Recipes 104 may also specify that the data be placed in specified locations within a specified one of data stores 112 via use of paste tags. For example, if the specified data store is a spreadsheet, certain cells of the spreadsheet may include paste tags such as [Impressions], [Revenue], and the like. Recipes 104 may specify that portions of the data retrieved from the data store corresponding to impressions be stored in place of [Impressions] paste tags in the spreadsheet, and that the data retrieved from the data store corresponding to revenue be stored in place of [Revenue] plate tags in the spreadsheet, for example.

Recipes 104 may also specify additional processes that may operate on the data stored in the data store. For example, if the specified data store is a spreadsheet, recipe 104 may specify spreadsheet macros that operate on data stored in a spreadsheet. As another example, the processes that may be specified by recipes 104 to operate on the data stored in the data store may include processes that generate a report based on the data stored in the data store.

In accordance with an aspect of the present disclosure, DDS 102 may receive one or more instructions included in one of recipes 104. The one or more instructions in the recipe may specify at least one template 106, for retrieving data from an associated one of data sources 110. In response to receiving the one or more instructions included in the recipe, DDS 102 may process the one or more instructions and may retrieve the data from the associated one of data sources 110 using the template 106. Retrieving the data from the data source may include inserting one or more parameters specified by the one or more instructions in the recipe into the template 106, and may further include passing the template to an associated one of handlers 108. The handler may execute the code included in the template 106 against the data source to request and receive data from the data source.

DDS 102 may persist the data retrieved from the data source. The one or more instructions included in the recipe may specify that one or more transformation modules of transformation module 114 perform one or more transformations on the data retrieved from the data source. In response to receiving data from the data source, DDS 102 may process the one or more instructions in the recipe that specifies the one or more transformations to be performed by the transformation module, and may enable the transformation module to perform one or more transformations to the data based on the one or more instructions included in the recipe. DDS 102 may process the one or more instructions in the recipe that specifies the location in one of data stores 112 into which the data is placed, and DDS 102 may insert the transformed data into one or more locations in the data store specified by the one or more instructions included in the recipe. DDS 102 may further process one or more instructions in the recipe that specifies a macro or other processes to be executed against the data in the data store and may execute the specified macro or process against the data in the data store based on the one or more instructions included in the recipe.

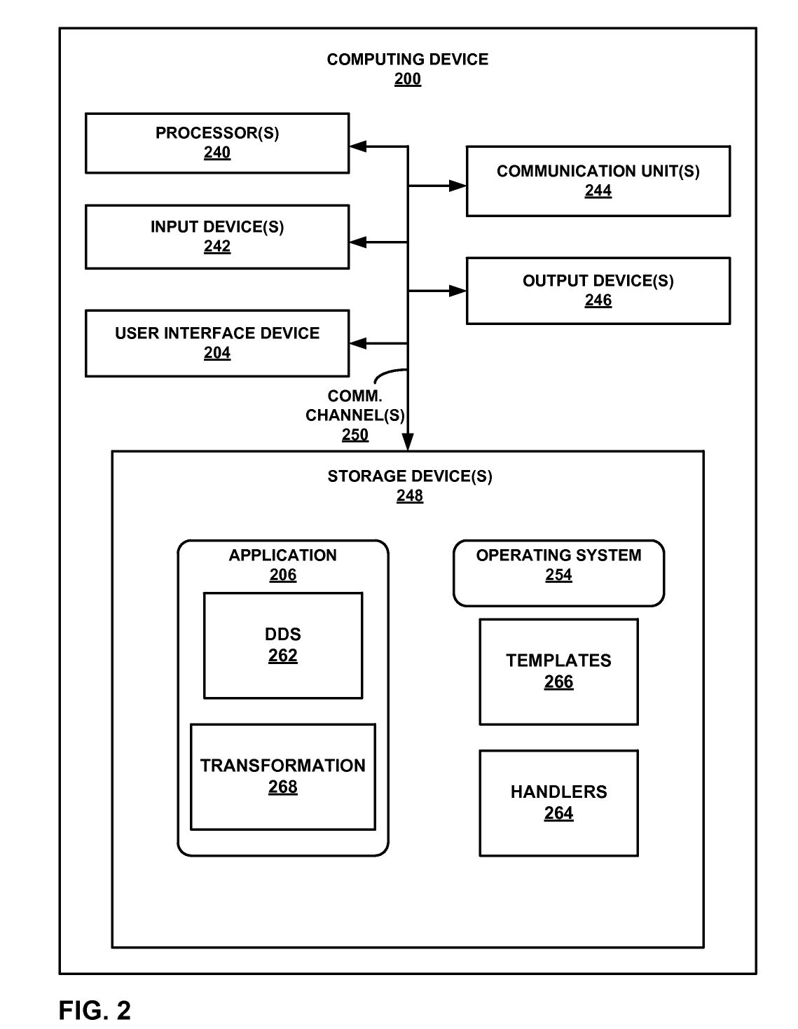

FIG. 2 is a block diagram illustrating an example computing device according to some aspects of the present disclosure. In some examples, computing device 2 can include fewer, additional, or different components compared to those illustrated in FIG. 2. As shown in the example of FIG. 2, computing device 200 may include one or more processors 240, one or more input devices 242, one or more communication units 244, one or more output devices 246, user interface device 204, and one or more storage devices 248. In this example, storage devices 248 of computing device 200 may include operating system 254, and an application 206. Communication channels 50 may interconnect each of the components 204, 240, 242, 244, 246, and 248 for inter-component communications (physically, communicatively, and/or operatively). In some examples, communication channels 250 may include a system bus, a network connection, an inter-process communication data structure, or any other method for communicating data.

One or more input devices 242 of computing device 200 may receive input. Examples of input are tactile, audio, and video input. Input devices 242 of computing device 200, in one example, include a presence-sensitive display, touch-sensitive screen, mouse, keyboard, voice responsive system, video camera, microphone or any other type of device for detecting input from a human or machine.

One or more output devices 246 of computing device 200 may generate output. Examples of output are tactile, audio, and video output. Output devices 246 of computing device 200, in one example, include a presence-sensitive display, sound card, video graphics adapter card, speaker, cathode ray tube (CRT) monitor, liquid crystal display (LCD), or any other type of device for generating output to a human or machine. In some examples, user interface device 204 may include one of one or more output devices 246. For example, user interface device 204 may include a display.

One or more communication units 244 of computing device 200 may communicate with wired or wireless external devices via one or more networks by transmitting and/or receiving network signals on the one or more networks. For example, computing device 200 may use communication units 244 to transmit and/or receive radio signals on a radio network such as a cellular radio network. Likewise, communication units 244 may transmit and/or receive satellite signals on a satellite network such as a GPS network. Examples of communication units 244 include a network interface card (e.g., such as an Ethernet card), an optical transceiver, a radio frequency transceiver, a GPS receiver, or any other type of device that can send and/or receive information. Other examples of communication units 244 may include Bluetooth®, GPS, 3G, 4G, and Wi-Fi® radios found in mobile devices as well as Universal Serial Bus (USB) controllers.

One or more storage devices 248 within computing device 200 may store information required for use during operation of computing device 200. Storage devices 248, in some examples, have the primary purpose of being short term and not long-term computer-readable storage mediums. Storage devices 248 on computing device 200 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art. Storage devices 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage devices 248 may store program instructions and/or data associated with one or more of application 206.

One or more processors 240 may implement functionality and/or execute instructions within computing device 200. For example, processors 240 on computing device 200 may read and execute instructions stored by storage devices 248 that execute the functionality of application 206. These instructions executed by processors 240 may cause computing device 200 to store information within storage devices 248 during program execution. Processors 240 may execute application 206 to perform various actions.

Storage devices 248 may include application 206. Application 206 may execute on processors 240 to receive a document via communication units 244 and to render the content specified by the received document for display at a display device, such as user interface device 204 included or otherwise operably coupled to computing device 200.

Application 206 may include data driven synthesizer (DDS) 262, similar to DDS 102 shown in FIG. 1. Computing device 200 may receive, via communication units 244 or input devices 242, a recipe, such as recipe 104 shown in FIG. 1. The recipe may include one or more instructions written in a domain specific language for DDS 262. DDS 262 may process the one or more instructions in the recipe, including translating the one or more instructions into machine language for computing device 200 so that the one or more instructions may be executed by processors 240. DDS 262 may retrieve any templates specified by the recipe from templates 266, similar to templates 106 shown in FIG. 1, and may replace parameters in the template(s) with the values specified in the recipe. DDS 262 may also select an appropriate handler out of handlers 264, similar to handlers 108 shown in FIG. 1, to communicate with the data source associated with the template.

DDS 262 may, via communication units 244 and the appropriate handler for the data source, communicate with the data source to retrieve data. DDS 262 may, after retrieving the data, persist the data in storage device 248. DDS 262 may also, based on the recipe, trigger transformation application 268 to perform one or more functions, such as statistical analysis, to the retrieved data. DDS 262 may also, based on the recipe, store the data in a document and/or data store in storage device 248.

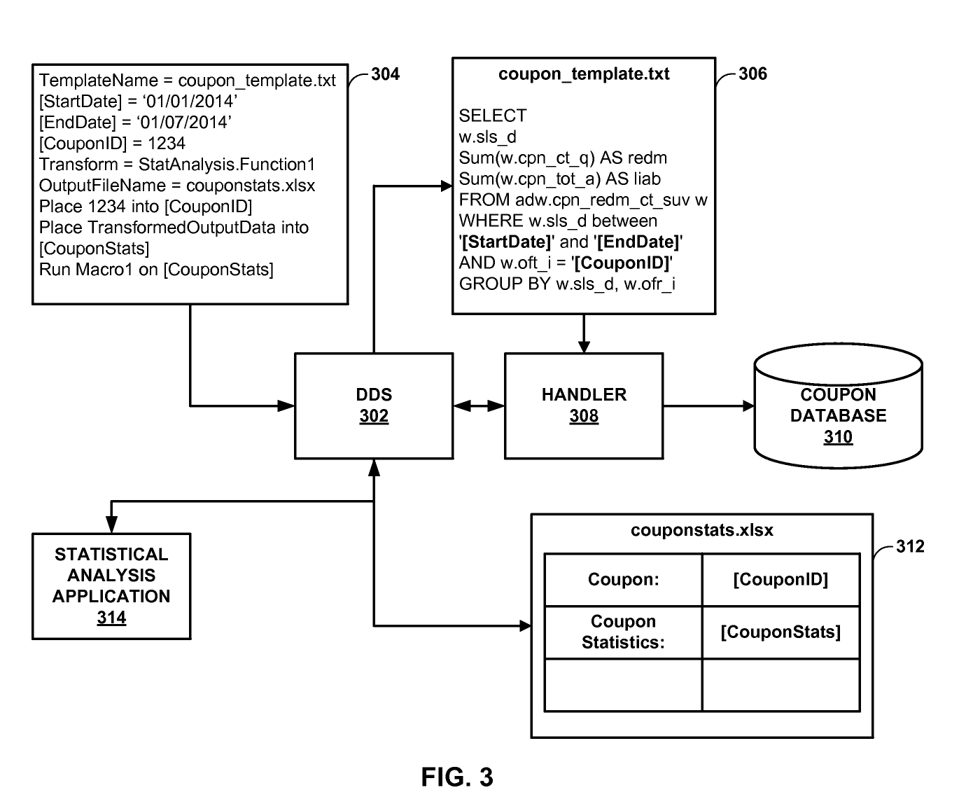

FIG. 3 is a block diagram illustrating an example system for generating reports of coupon usage according to some aspects of the present disclosure. As shown in FIG. 3, an example recipe 304, similar to one of recipes 104 shown in FIG. 1, may be communicated to DDS 302, similar to DDS 102 shown in FIG. 1. Example recipe 304 includes the following example instructions:
TemplateName=coupon_template.txt
[StartDate]=‘01/01/2014’
[EndDate]=‘01/07/2014’
[CouponID]=1234
Transform=StatAnalysis.Function1
OutputFileName=couponstats.xlsx
Place 1234 into [CouponID]
Place TransformedOutputData into [CouponStats]
Run Macro1 on [CouponStats]

Recipe 304 may specify a coupon_template.txt text document as the template 306 for recipe 304. Example template 306, similar to one of templates 106 shown in FIG. 1, includes the following example instructions for retrieving data from a data source:
SELECT
w.sls_d
Sum(w.cpn_ct_q) AS redm
Sum(w.cpn_tot_a) AS liab
FROM adw.cpn_redm_ct_suv w
WHERE w.sls_d between ‘[StartDate]’ and ‘[EndDate]’
AND w.oft_i=‘[CouponID]’
GROUP BY w.sls_d, w.ofr_i

Template 306 may include instructions for retrieving specified data from a data store, and may include, for example, parameters [StartDate], [EndDate] and [CouponID] in its instructions. Template 306 may retrieve coupon use details for a coupon specified by the parameter [CouponID] between the dates specified by the parameters [StartDate] and [EndDate].

DDS 302 may process the instructions in example recipe 304 and may retrieve the coupon template.txt template based on the instructions in recipe 304. Because recipe 304 defines values for parameters [StartDate], [EndDate] and [CouponID] as [StartDate]=‘01/01/2014’, [EndDate]=‘01/07/2014’, and [CouponID]=1234, DDS 302 may replace the parameters [StartDate], [EndDate] and [CouponID] in template 306 with the values ‘01/01/2014’, ‘01/07/2014’, and 1234, respectively.

DDS 302 may, based on the instructions in recipe 304, determine that recipe 304 includes a request for data from coupon database 310. DD 302 may select an associated handler, such as handler 308, similar to one of handlers 108 shown in FIG. 1., to communicate with coupon database 310. DDS 302 may pass filled-in template 306 to handler 308, and handler 308 may execute the instructions in template 306 against coupon database 310 to retrieve data. The data retrieved from coupon database 310 may be returned to DDS 302, and DDS 302 may persist the retrieved data.

Recipe 304 may specify a specific statistical analysis application 314 and a specific function of statistical analysis application 314 to perform on the retrieved data. In the example of FIG. 3, recipe 304 includes the instruction Transform=StatAnalysis.Function1 that specifies the StatAnalysis application to perform Function1 on the retrieved data. DDS 302 may, based on the instruction in recipe 304, pass the retrieved data to statistical analysis application 314 and may pass instructions for statistical analysis application 314 to perform the specified Function1 on the data, and statistical analysis application 314 may return the transformed data back to DDS 302.

Recipe 304 may specify a location of a specific data store into which the transformed data is placed. In the example of FIG. 3, recipe 304 includes the instructions of OutputFileName=couponstats.xlsx, Place 1234 into [CouponID], and Place TransformedOutputData into [CouponStats]. DDS 302 may, based on the instructions in recipe 304, place the value of 1234 into the [CouponID] paste tag in couponstats.xlsx 312, and may place the transformed output data into the [CouponStats] paste tag in couponstats.xlsx 312. As discussed above, because couponstats.xlsx 312 is a Microsoft Excel spreadsheet, DDS 304 may directly operate on the data model of couponstats.xlsx 312 to place the data into the paste tags by using Apache POI.

Recipe 304 may further specify additional operations that may be performed on the data placed into couponstats.xlsx 312. In the example of FIG. 3, recipe 304 includes the instruction of Run Macro1 on [CouponStats], which specifies that Macro1 be performed on the data placed into the [CouponStats] paste tag in couponstats.xlsx 312. DDS 302 may, based on the instruction in recipe 304, enable the specified Macro1 to be performed on the data placed into the [CouponStats] paste tag in couponstats.xlsx 312. In this way, the instructions in recipe 304 enable DDS 302 to perform a process of retrieving data from a data source, transforming the data, and placing the data into specified locations of a data store.

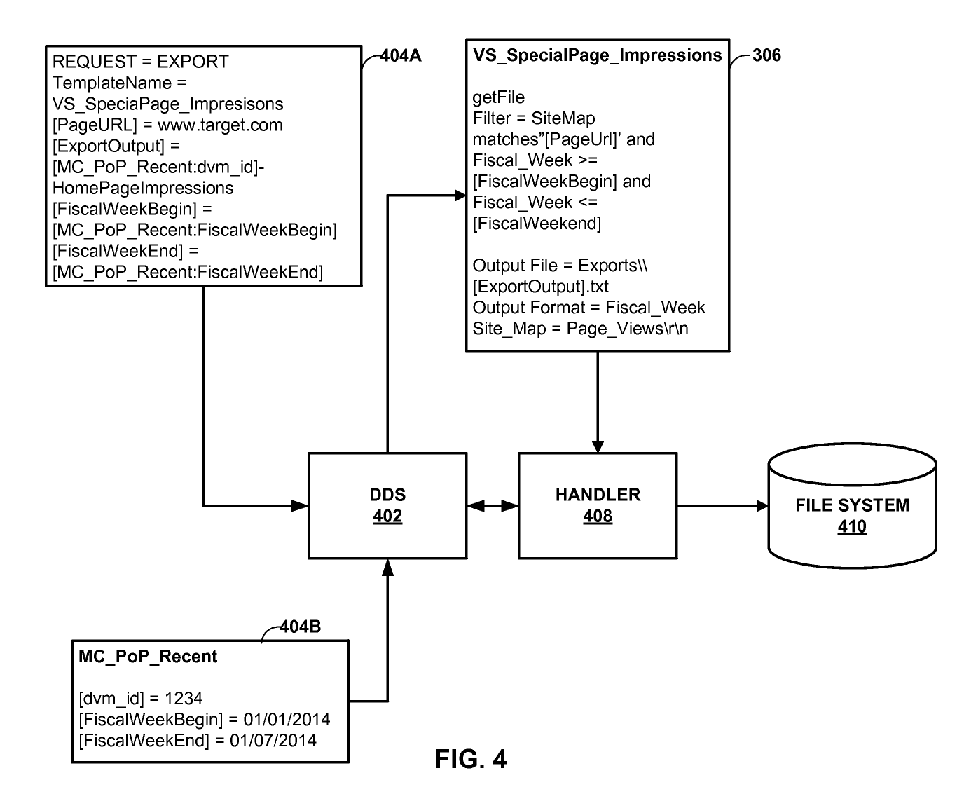

FIG. 4 is a block diagram illustrating an example system for generating reports of data using nested recipes according to some aspects of the present disclosure. As shown in FIG. 4, an example recipe 404A, similar to one of recipes 104 shown in FIG. 1, may be communicated to DDS 402, similar to DDS 102 shown in FIG. 1. Example recipe 404A may include the following instructions:
REQUEST=EXPORT
TemplateName=VS_SpeciaPage_Impressions
[PageURL]=www.target.com
[ExportOutput]=[MC_PoP_Recent:dvm_id]-HomePageImpressions
[FiscalWeekBegin]=[MC_PoP_Recent:FiscalWeekBegin]
[FiscalWeekEnd]=[MC_PoP_Recent:FiscalWeekEnd]

Recipe 404A may define values for parameters [PageURL], [ExportOutput], [FiscalWeekBegin], and [FiscalWeekEnd]. However, in this example, recipe 404A does not directly define values for parameters [ExportOutput], [FiscalWeekBegin], and [FiscalWeekEnd]. Instead, recipe 404A refers to another recipe MC_PoP_Recent for the values of these parameters. In the example of FIG. 4, the value of parameter [ExportOutput] is based in part on the value defined by recipe MC_PoP_Recent for its parameter [dvm_id], the value of [FiscalWeekBegin] is the value defined by recipe MC_PoP_Recent for its parameter [FiscalWeekBegin], and the value of [FiscalWeekEnd] is the value defined by recipe MC_PoP_Recent for its parameter [FiscalWeekEnd]. Recipe 404B may include recipe MC_PoP_Recent and may, for example, define the value of [dvm_id] as 1234, define the value of [FiscalWeekBegin] as 01/01/2014, and define the value of [FiscalWeekEnd] as 1/07/2014.

DDS 402 may receive example recipes 404A and 404B. Based on recipe 404A, DDS 402 may retrieve template VS_SpecialPage_Impressions 406. DDS 402 may replace the parameters in template 406 with the values defined in recipe 404A. Because some of the values defined for parameters by recipe 404A depends on the values of parameters in recipe 404B, DDS 402 may read recipe 404B in conjunction with reading 404A to insert the proper values in place of parameters [ExportOutput], [FiscalWeekBegin], and [FiscalWeekEnd] in template 406. DDS 402 may send template 406 to handler 408, and handler 408 may execute template 406 to retrieve data from file system 410. In this way, recipe 404A may nest recipe 404B so that recipe 404A may define values for parameters in terms of the values defined for parameters in recipe 404B.

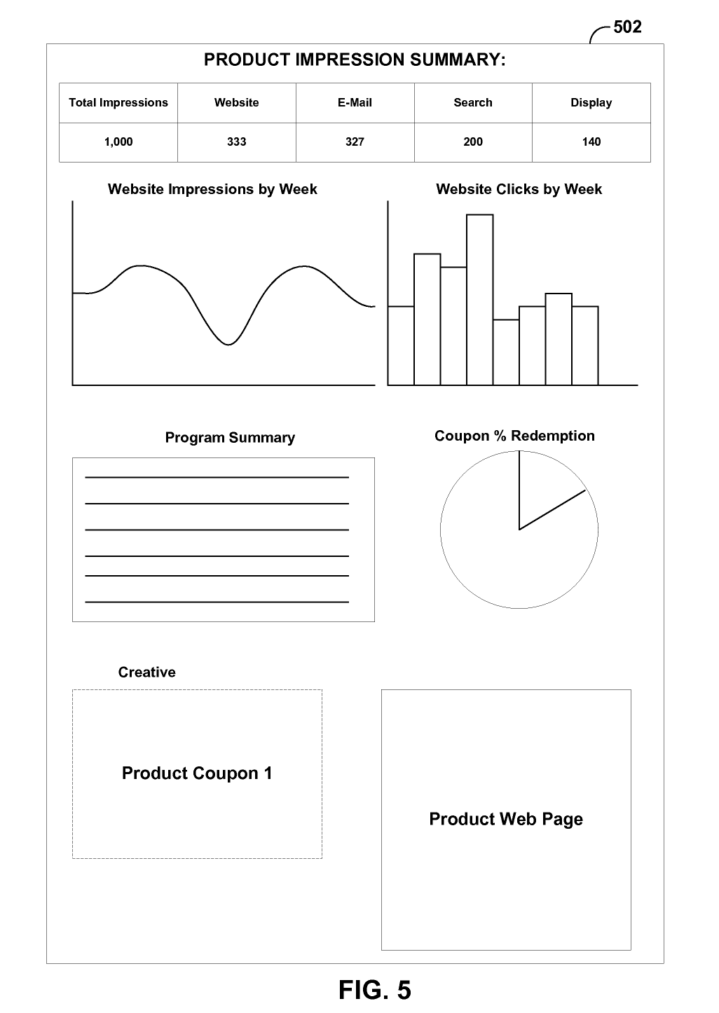

FIG. 5 is a conceptual diagram illustrating an example generated report according to some aspects of the present disclosure. A report may be generated using data retrieved, transformed, and stored via the techniques described above with respect to FIGS. 1-4. As shown in FIG. 5, a report 502 may include, for example, a summary of impressions received for a particular product that is being sold online and in retail stores during a marketing campaign for the product. An impression, in one example, may include a delivered basic advertising unit for the product. Report 502 may, for example, include the number of impressions the product received, and may break down the impressions received by whether the impression was received through the store's website, e-mail campaigns, a user's search results, or a physical display at the retail store. Report 502 may, for example, also include charts and graphs regarding the impressions received by the product via the store's website and the number of website clicks received for the product. Report 502 may also include coupon redemption statistics for the product. Report 502 may also include additional information, such as the marketing program summary for the product, the product coupons used to promote the product, as well as the product's web page on the store's website.

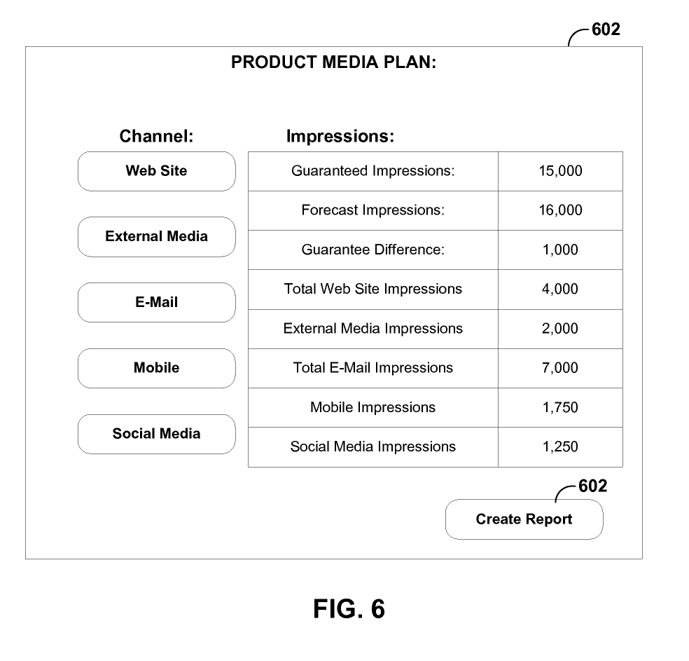

FIG. 6 is a conceptual diagram illustrating an example user interface for generating reports according to some aspects of the present disclosure. As shown in FIG. 6, user interface 602 may be provided by a software application to a user, such as a business analyst, so that the business analyst may be able to create a report, such as report 502 shown in FIG. 5, via an easy-to-use user interface. For example, user interface 602 may include a user interface for creating a report regarding the number of impressions for a product from a variety of channels. For example, user may select the channels to include in a report, such as by clicking buttons or otherwise interacting with user interface elements of user interface 602. In response, a recipe for retrieving data regarding channel impressions may be edited so that it retrieves data for the channels selected by the user. User interface 602 may also display the data retrieved in response to the user input. If the user is satisfied with the results, the user may interact with user interface 602 to create the report, such as by clicking “Create Report” button 604.

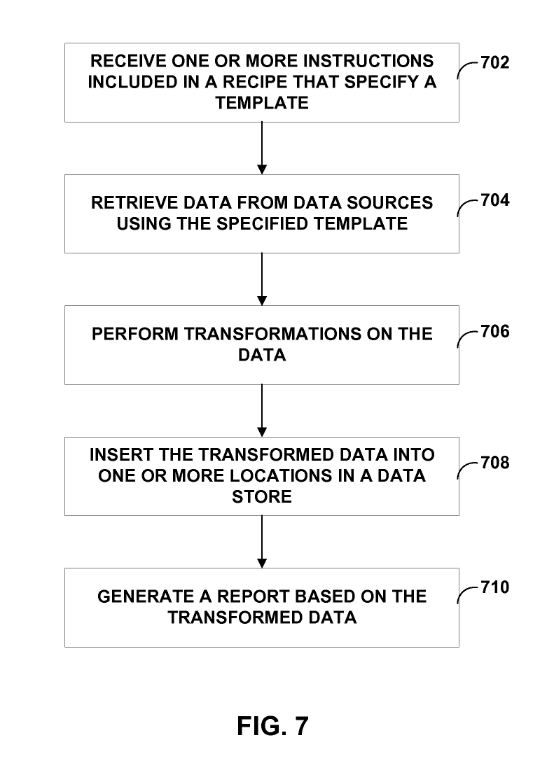

FIG. 7 is a flowchart illustrating a method for generating reports of data according to some aspects of the present disclosure. As shown in FIG. 7, data driven synthesizer (DDS) 102 may receive one or more instructions, wherein the one or more instructions specify a template 106 for retrieving data from one or more data sources 110 (702). In response to receiving the one or more instructions, DDS 102 may retrieve the data from the one or more data sources 110 using the template 106, including inserting one or values specified by the one or more instructions in place of one or more parameters in the template 106 (704). Transformation module 114 may perform one or more transformations on the data based on the one or more instructions (706). DDS 102 may insert the transformed data into one or more locations in a data store 112 specified by the one or more instructions (708).

In some examples, retrieving the data from the one or more data sources may further include sending, by DDS 102, the template 106 to one or more handlers 108 associated with the one or more data sources 110 and executing, by the one or more handlers 108, instructions included in the template 106. In some examples the data store 112 comprises a document. In some examples, the process may further include triggering one or more macros that operate on the data stored in the document based on the one or more instructions. In some examples, inserting the transformed data into one or more locations in a data store 112 specified by the one or more instructions further includes placing the transformed data in the document in place of one or more paste tags in the document based on the one or more instructions. In some examples, the process may further include generating a report based on the transformed data stored in the data store 112. In some examples, the one or more instructions included in the recipe 104 specify the one or more values for the one or more instructions by referring to a second recipe that defines the one or more values for the one or more instructions.

As will be appreciated by one skilled in the art, aspects of the present disclosure may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may include a computer readable signal medium or a computer readable storage medium. A computer readable storage medium may include, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may include any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may include any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described above with reference to flowchart illustrations and/or block diagrams of methods, apparatus (systems) and computer program products according to aspects of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Various aspects of the disclosure have been described. These and other aspects are within the scope of the following claims.

1. A method comprising:
receiving, by a data driven synthesizer running on at least one processor, one or more instructions included in a recipe, wherein the one or more instructions specify a template for retrieving data from one or more data sources;
in response to receiving the one or more instructions, retrieving, by the data driven synthesizer, the data from the one or more data sources using the template, including inserting one or more values specified by the one or more instructions in place of one or more parameters in the template;
performing one or more transformations on the data based on the one or more instructions; and
inserting the transformed data into one or more locations in a data store specified by the one or more instructions.

2. The method of claim 1, wherein retrieving the data from the one or more data sources comprises:
sending, by the data driven synthesizer, the template to one or more handlers associated with the one or more data sources; and
executing, by the one or more handlers, instructions included in the template.

3. The method of claim 1, wherein the data store comprises a document.

4. The method of claim 3, further comprising:
triggering one or more macros that operate on the transformed data stored in the document based on the one or more instructions.

5. The method of claim 3, wherein inserting the transformed data into one or more locations in a data store specified by the one or more instructions further comprises:
placing the transformed data in the document in place of one or more paste tags in the document based on the one or more instructions.

6. The method of claim 1, further comprising:
generating a report based on the transformed data stored in the data store.

7. The method of claim 1, wherein the one or more instructions included in the recipe specifies the one or more values for the one or more instructions by referring to a second recipe that defines the one or more values for the one or more instructions.

8. A computer-readable medium comprising instructions that, when executed by at least one processor, causes the at least one processor to perform operations comprising:
receiving, by a data driven synthesizer, one or more instructions included in a recipe, wherein the one or more instructions specify a template for retrieving data from one or more data sources;
in response to receiving the one or more instructions, retrieving, by the data driven synthesizer, the data from the one or more data sources using the template, including inserting one or more values specified by the one or more instructions in place of one or more parameters in the template;
inserting the data into one or more locations in a data store specified by the one or more instructions; and
triggering one or more macros that operate on the data stored in the data store based on the one or more instructions.

9. The computer-readable medium of claim 8, wherein retrieving the data from the one or more data sources comprises:
sending, by the data driven synthesizer, the template to one or more handlers associated with the one or more data sources; and
executing, by the one or more handlers, instructions included in the template.

10. The computer-readable medium of claim 8, wherein the data store comprises a document.

11. The computer-readable medium of claim 10, the operations further comprising:
performing one or more transformations on the data based on the one or more instructions.

12. The computer-readable medium of claim 10, wherein inserting the data into one or more locations in a data store specified by the one or more instructions further comprises:
placing the data in the document in place of one or more paste tags in the document based on the one or more instructions.

13. The computer-readable medium of claim 12, the operations further comprising:
generating a report based on the data stored in the document.

14. The computer-readable medium of claim 8, wherein the one or more instructions included in the recipe specifies the one or more values for the one or more instructions by referring to a second recipe that defines the one or more values for the one or more instructions.

15. A system comprising:
at least one processor;
at least one memory device; and
at least one module stored by the at least one memory device and executable by the at least one processor, wherein the at least one module is configured to perform operations comprising:
receiving, by a data driven synthesizer, one or more instructions included in a recipe, wherein the one or more instructions specify a template for retrieving data from one or more data sources;
in response to receiving the one or more instructions, retrieving, by the data driven synthesizer, the data from the one or more data sources using the template;
performing one or more transformations on the data based on the one or more instructions; and
inserting the transformed data in place of one or more paste tags in a document based on the one or more instructions.

16. The system of claim 15, wherein retrieving the data from the one or more data sources comprises:
sending, by the data driven synthesizer, the template to one or more handlers associated with the one or more data sources; and
executing, by the one or more handlers, instructions included in the template.

17. The system of claim 15, wherein the operations further comprises:
triggering one or more macros that operate on the transformed data stored in the document based on the one or more instructions.

18. The system of claim 15, further comprising:
generating a report based on the transformed data stored in the document.

19. The system of claim 15, wherein the one or more instructions included in the recipe specifies the one or more values for the one or more instructions by referring to a second recipe that defines the one or more values for the one or more instructions.

20. The system of claim 15, wherein retrieving, by the data driven synthesizer, the data from the one or more data sources using the template further comprises:
inserting one or more values specified by the one or more instructions in place of one or more parameters in the template.
